(19) United States
(12) Patent Application Publication
(10) Pub. No.: US 2007/0288604 A1
(43) Pub. Date: Dec. 13, 2007

(54) METHOD FOR DETERMINING OPTIMAL NUMBER OF CONNECTIONS IN MULTI-CONNECTION DOWNLOAD CONFIGURATION

(76) Inventors: Jeffrey Mark Achtermann, Austin, TX (US); Irwin Boutboul, Jersey City, NJ (US); Lawrence Hugh Maddox, Austin, TX (US); Liliana Orozco, Del Valle, TX (US)

Correspondence Address: IBM CORP (YA);C/O YEE & ASSOCIATES PC, P.O. BOX 802333, DALLAS, TX, 75380, US

(21) Appl. No.: 11/422,893

(22) Filed: Jun. 8, 2006

(51) Int. Cl. G06F 15/177

(52) U.S. Cl. 709/220

(57) ABSTRACT

A method is provided to determine the optimal number of servers to connect to a download client, in order to achieve efficient file transfer. A number of connections are initially opened between the client and servers, and after waiting for a stabilization period, the over-all transfer speed is determined for the initial connected sources. Thereafter, source connections are sequentially added, until it is determined that adding a further connection will not increase the over-all transfer rate by at least an amount provided by a specified algorithm. One embodiment of the invention is directed to a method for use in a network configuration comprising a client and multiple servers, wherein the client is connectible to a number of the servers to simultaneously transfer respective portions of a specified file. After connecting an initial number of servers to the client, an additional source, associated with a transfer rate improvement factor, is connected thereto. The over-all transfer rate, collectively provided by the client connections to the initial number of servers and to the additional server, is compared with a saturation indicator value, to determine whether any further servers should be connected to the client.

### BACKGROUND OF THE INVENTION

1. Field of the Invention:

The invention disclosed and claimed herein generally pertains to a network downloading configuration, wherein a computer client is connected to multiple servers that simultaneously transfer respective portions of a file or files to the client. More particularly, the invention pertains to a method for a network configuration of the above type, wherein the method determines an optimal number of server connections to be used for transferring a file to the client. The invention further pertains to a method of the above type wherein server connections are progressively added to increase file transfer rate, until the optimal number is reached.

2. Description of the Related Art:

In order to rapidly transfer a file or files to a computer client, multiple servers may be connected to the client at the same time, wherein each server contains the entire file or other material which is to be transferred. Different parts or portions of the file can then be downloaded to the client simultaneously, from the respective connected servers.

In multiple, simultaneous connection download arrangements of the above type, a significant problem is determining the ideal number of connections to open or establish between the download client and available servers. In opening respective connections, the desired objective is to maximize download speed or transfer rate, while at the same time evenly distributing the work among the connected servers. The ideal or optimal number of connections depends on several factors, particularly the download client's connection throughput and what each connection is capable of providing.

Generally, each server or other file source connected to a download client increases the over-all transfer speed, that is, the rate at which file information is being transferred by the collective operation of all the connected sources. Accordingly, one current approach for determining the ideal number of connections is to keep adding connections, until the over-all transfer speed does not increase anymore. However, a drawback to this approach is that measuring transfer speed tends to be very volatile. Due to faulty measurement, a connection could be added that in fact provided very little or no increase in over-all transfer speed, and was thus unnecessary.

A second solution is to use an algorithm, whereby connections are continually added until the over-all transfer speed does not increase by more than a certain percentage factor. A drawback to this solution is that if the last connection added is very slow, the over-all transfer speed might in fact not have increased by any significant percentage. Then, even though another connection was necessary, the algorithm would determine that maximum transfer rate had been reached.

### SUMMARY OF THE INVENTION

The invention provides a method wherein an initial number of connections are opened between a download client and servers or other sources of file information. After starting each of the initial connections and waiting for a stabilization period, the over-all transfer speed is determined, for the initial number of connected sources. Thereafter, source connections are sequentially added, until it is determined that adding a further connection will not increase the over-all transfer rate by at least a minimum amount, provided by a specified algorithm. One embodiment of the invention is directed to a method of the above type wherein a client is connectible to a number of sources, in order to simultaneously download respective portions of a file. The method determines an optimal number of sources to connect to the client for file transfer. The method comprises the steps of connecting an initial number of the sources to the client, and then connecting an additional source to the client, wherein the additional source is associated with a transfer rate improvement factor. The method further includes determining the over-all transfer rate resulting from the collective effects of the initial number of source connections, and the additional source connection. The over-all transfer rate is compared with a saturation indicator value, to determine whether any further sources should be connected to the client.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a schematic diagram showing a network configuration comprising a client and a number of file sources, for illustrating an embodiment of the invention.

FIG. 2 is a block diagram depicting a network configuration of the type shown in FIG. 1 in greater detail.

FIG. 3 is a block diagram showing a computer or data processing system that may be used as a download client in the network configuration of FIG. 2.

FIG. 4 is a flowchart showing respective steps for a method in accordance with an embodiment of the invention.

### DETAILED DESCRIPTION OF THE PREFERRED EMBODIMENT

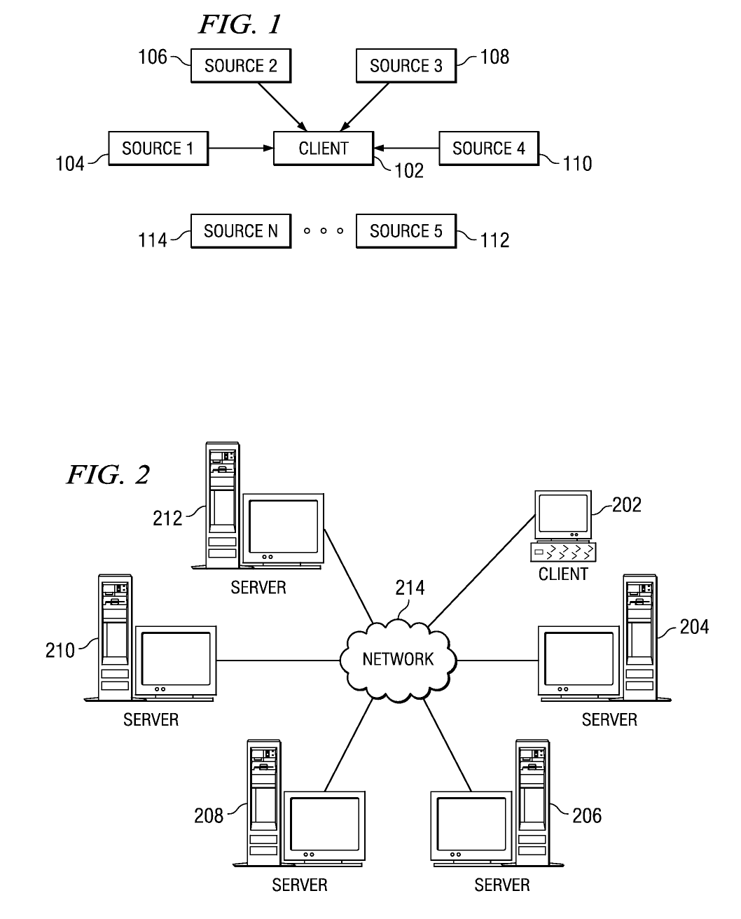

Referring to FIG. 1, there is shown a computer client 102 that may readily be connected to and disconnected from each of a number of file sources 104-114. These sources all contain an identical file or files. Accordingly, in order to rapidly download the file or files to client 102, connections could be opened between the client and a plurality of the sources 104-114. Different parts of the file would then be transferred simultaneously to client 102, from the different connected sources. These sources, which usefully comprise servers, are also referred to as sources 1-5 and source N, respectively.

For convenience, the term “connection” is used herein to refer to a connection that has been established between the computer client and a particular server or file source. Similarly, the term “connections” is used herein to refer to a number of connections that have been established between the computer client and each of a plurality of discrete servers or file sources.

In embodiments of the invention, a configurable number of such source connections are initially opened. It will be appreciated that the number of initial connections can be dependent on the size of the file being downloaded. The transfer rates of these initial connections are not checked to see if the configuration of initial connections provides saturation, as such term is described hereinafter.

After all the initial source connections have been started and given a time to stabilize, the over-all transfer speed of the initial connections is measured. Then, another connection is opened and given the same amount of time to stabilize. Thereupon, the new over-all transfer speed is measured, along with the individual transfer speed of the last added connection. The last connection is deemed necessary only if it is found to increase the over-all transfer rate by a transfer rate improvement factor, which comprises a certain percentage of the last connection transfer rate. This percentage or factor is used in an algorithm as described hereinafter. If the last connection is found to be necessary, another connection is opened, and the algorithm is again referred to. This process is continually repeated, with a new connection being added for each repetition, until adding another connection does not increase the over-all transfer rate by at least a specified percentage of the transfer rate of the last added connection.

FIG. 2 shows a client 202 that can connect to any of a number of file sources, such as servers 204-212, through a network 214. Network 214 may, for example, comprise a LAN network. Each of the servers 204-212 contains an identical file or files. As described above in connection with FIG. 1, client 202 can rapidly download these files by establishing multiple connections with a selected number of the servers. An embodiment of the invention can be used to readily determine an optimal number of servers for the client to connect to, in order to achieve a near-maximum transfer rate, while also evenly distributing the work among the servers. The embodiment may be implemented by client 202, and client 202 can further be operated to set up connections with respective servers, as required for a rapid and efficient file transfer.

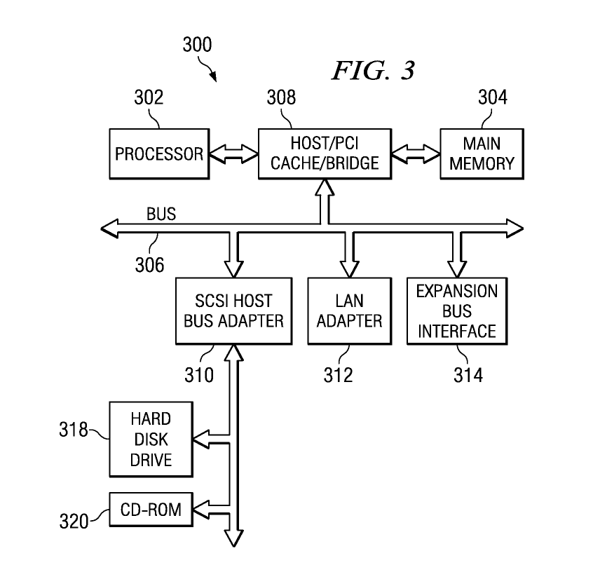

Referring to FIG. 3, there is shown a block diagram of a generalized data processing system 300 which may be used as client 202. Data processing system 300 exemplifies a computer, in which code or instructions for implementing the processes of the present invention may be located. Data processing system 300 usefully employs a peripheral component interconnect (PCI) local bus architecture, although other bus architectures may alternatively be used. FIG. 3 shows a processor 302 and main memory 304 connected to a PCI local bus 306 through a Host/PCI bridge 308. PCI bridge 308 also may include an integrated memory controller and cache memory for processor 302.

Referring further to FIG. 3, there is shown a local area network (LAN) adapter 312, a small computer system interface (SCSI) host bus adapter 310, and an expansion bus interface 314 respectively connected to PCI local bus 306 by direct component connection. SCSI host bus adapter 310 provides a connection for hard disk drive 318, and also for CD-ROM drive 320.

An operating system runs on processor 302 and is used to coordinate and provide control of various components within data processing system 300 shown in FIG. 3. The operating system may be a commercially available operating system such as Windows XP, which is available from Microsoft Corporation. Instructions for the operating system and for applications or programs are located on storage devices, such as hard disk drive 320, and may be loaded into main memory 304 for execution by processor 302.

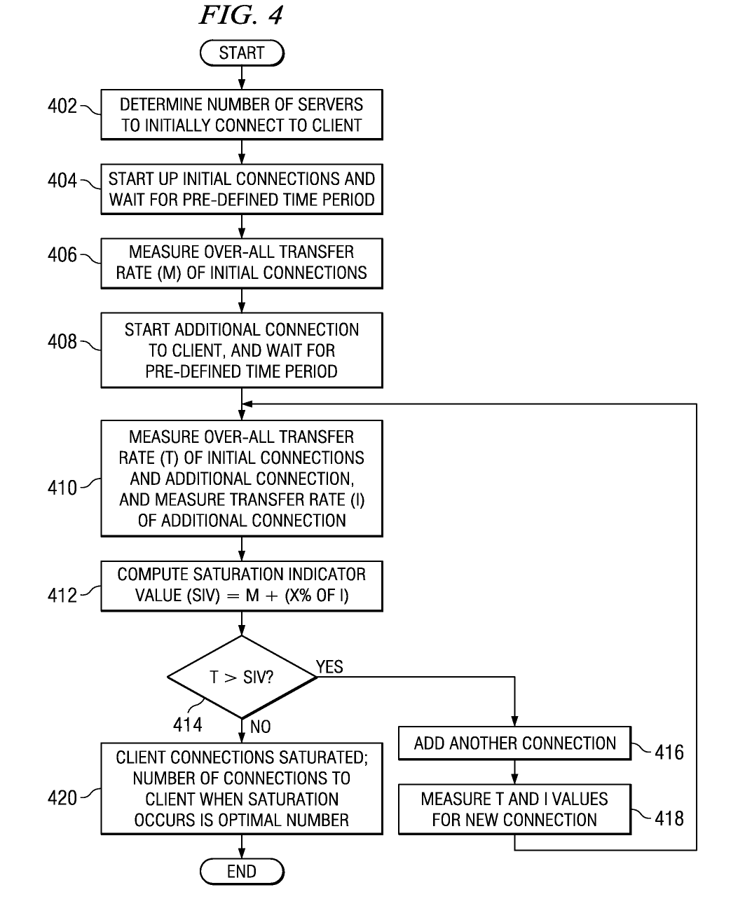

In embodiments of the invention, a basic concept is to add a new connection to a client, to join a group of previous connections. The over-all transfer rate, including effects of the new connection, is then measured and an assessment is made to determine whether adding the new connection has significantly increased the over-all transfer rate. The assessment is carried out by using a saturation indicator value derived from an algorithm, as described hereinafter in connection with FIG. 4. If the assessment indicates that the over-all transfer was not increased significantly by the new connection, the connections to the client then in place are considered to be saturated. That is, it is concluded that adding any more connections would not be worthwhile.

On the other hand, if the assessment shows that the new connection has significantly increased the over-all transfer rate, another connection is added, and the over-all transfer rate with this connection is assessed. Generally, the process of adding a connection, and then assessing the over-all transfer rate with the added connection, continues until saturation is reached. The total number of connections when saturation occurs is taken to be the optimal number for the client and its associated servers, to use for the particular intended file transfer.

Referring to FIG. 4, there are shown a number of steps which may be carried out in implementing an embodiment of the invention as described above. The network configuration of FIG. 2, for example, may be operated in accordance with FIG. 4. At step 402, an initial number of server connections is selected, for example three initial connections. At step 404 the initial connections are simultaneously started, and then operated for a pre-defined time period. During this period, which may for example be five seconds, the transfer rate of each of the initial connections is able to stabilize.

Following the stabilization period, the over-all transfer rate M of the initial connections is measured, as indicated by step 406. The rate M could, for example, be 700 KB/s. As discussed above, over-all transfer rate is the rate at which file information is transferred by the collective operation of all the sources that are connected to the client, at a particular time. After the measurement of M, step 408 shows that an additional connection to the client is started, and this connection is allowed to stabilize during the pre-defined time period. Thereafter, over-all transfer rate T is measured, as shown by step 410, wherein T represents the collective transfer effects of the initial connections and the additional connection. At step 410 a transfer rate I is also measured, wherein I is the individual transfer rate of the additional connection.

Referring further to FIG. 4, step 412 shows an algorithm for use in computing a saturation indicator value (SIV) from the measured values of M and I. More particularly, at step 412, the computation SIV=M+(X% of I) is carried out, wherein X is a transfer rate improvement factor. More particularly, X is a percentage increase in over-all transfer rate provided by the new connection, which is expected over the transfer rate of the previous number of connections. X is configurable, that is, it may be different for different network configurations. In one embodiment, X is selected to be 75%.

As stated above, the saturation indicator value is used to assess the over-all transfer rate of the connections, following addition of a new connection. In accordance with such teaching, step 414 shows T being compared with SIV, to determine which is greater. If T is found to be greater than SIV, it is concluded that the last added connection did not saturate the network connection, and is thus benefiting the over-all transfer rate. Therefore, a new connection is added as shown by step 416, and the value of I for the new connection and the new over-all transfer rate of T are measured, as shown by step 418. These values are then used in repeating steps 412 and 414. Such process is continually repeated, with another connection being added for each repetition, until step 414 produces a negative decision.

Step 420 shows that the client connections are at saturation, when the over-all transfer rate for a particular number of connections is found to be less than the saturation indicator value therefor. The total number of connections in place when this occurs is determined to be the optimal number for the intended file transfer.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. In a network configuration comprising a client and multiple sources of file information, wherein the client is connectible to a number of the sources in order to simultaneously transfer respective portions of the specified file to the client, a method for determining an optimal number of sources to connect to the client for file transfer, said method comprising the steps of:
connecting an initial number of said sources to said client;
connecting an additional source to said client, wherein said additional source is associated with a transfer rate improvement factor;
determining the over-all transfer rate resulting from the collective effects of said initial number of source connections and said additional source connection; and
comparing said over-all transfer rate with a saturation indicator value, to determine whether any further sources should be connected to said client.

2. The method of claim 1, wherein:
said saturation indicator value is calculated as a function of said transfer rate improvement factor.

3. The method of claim 1, wherein:
when said over-all transfer rate is found to be greater than said saturation indicator value, a process is commenced, wherein said process comprises connecting a new source to said client, and repeating said determining and comparing steps, using values therefor that are respectively associated with the newly connected source.

4. The method of claim 3, wherein:
said process is repeated, each time the over-all transfer rate associated with a newly added source is found to be greater than the saturation indicator value associated therewith.

5. The method of claim 4, wherein:
when one of said saturator indicator values is found to be equal to or greater than the corresponding over-all transfer rate, the number of sources then connected to said client is taken to be said optimal number.

6. The method of claim 3, wherein:
said saturation indicator value is calculated as a function of the transfer rate improvement factor (X), the over-all transfer rate resulting from said initially connected sources (M), and the transfer rate of said newly connected source (I).

7. The method of claim 6, wherein:
said saturation indicator value (SIV) may be expressed as SIV=M+(X% of I).

8. The method of claim 7, wherein:
X is a percentage on the order of 75%.

9. In a network configuration comprising a client and multiple sources of file information, wherein the client is connectible to a number of the sources in order to simultaneously transfer respective portions of the specified file to the client, a computer program product in a computer readable medium for determining an optimal number of sources to connect to the client for file transfer, said computer program product comprising:
first instructions for connecting an initial number of said sources to said client;
second instructions for connecting an additional source to said client, wherein said additional source is associated with a transfer rate improvement factor;
third instructions for determining the over-all transfer rate resulting from the collective effects of said initial number of source connections and said additional source connection; and
fourth instructions for comparing said over-all transfer rate with a saturation indicator value, to determine whether any further sources should be connected to said client.

10. The computer program product of claim 9, wherein:
when said over-all transfer rate is found to be greater than said saturation indicator value, a process is commenced, wherein said process comprises connecting a new source to said client, and repeating said determining and comparing steps, using values therefor that are respectively associated with the newly connected source.

11. The computer program product of claim 10, wherein:
said process is repeated, each time the over-all transfer rate associated with a newly added source is found to be greater than the saturation indicator value associated therewith.

12. The computer program product of claim 11, wherein:
when one of said saturator indicator values is found to be equal to or greater than the corresponding over-all transfer rate, the number of sources then connected to said client is taken to be said optimal number.

13. The computer program product of claim 10, wherein:
said saturation indicator value is calculated as a function of the transfer rate improvement factor (X), the over-all transfer rate resulting from said initially connected sources (M), and the transfer rate of said newly connected source (I).

14. The computer program product of claim 13, wherein:
said saturation indicator value (SIV) may be expressed as SIV=M+(X% of I).

15. In a network configuration comprising a client and multiple sources of file information, wherein the client is connectible to a number of the sources in order to simultaneously transfer respective portions of the specified file to the client, apparatus for determining an optimal number of sources to connect to the client for file transfer, said apparatus comprising:
a first device for connecting an initial number of said sources to said client, and thereafter connecting an additional source to said client, wherein said additional source is associated with a transfer rate improvement factor;
a second device for determining the over-all transfer rate resulting from the collective effects of said initial number of source connections and said additional source connection; and
a third device for comparing said over-all transfer rate with a saturation indicator value, to determine whether any further sources should be connected to said client.

16. The apparatus of claim 15, wherein:
when said third device finds said over-all transfer rate to be greater than said saturation indicator value, a process is commenced, wherein said first device connects a new source to said client, said second device determines said over-all transfer rate, and said third device compares said over-all transfer rate with a saturation indicator value, using values therefor that are respectively associated with the newly connected source.

17. The apparatus of claim 16, wherein:
said process is repeated, each time the over-all transfer rate associated with a newly added source is found to be greater than the saturation indicator value associated therewith.

18. The apparatus of claim 16, wherein:
when said third device finds one of said saturator indicator values to be equal to or greater than the corresponding over-all transfer rate, the number of sources then connected to said client is taken to be said optimal number.

19. The apparatus of claim 16, wherein:
said saturation indicator value is calculated as a function of the transfer rate improvement factor (X), the over-all transfer rate resulting from said initially connected sources (M), and the transfer rate of said newly connected source (I).

20. The apparatus of claim 19, wherein:
said saturation indicator value (SIV) may be expressed as SIV=M+(X% of I).
